(19) United States
(12) Patent Application Publication
(10) Pub. No.: US 2018/0162478 A1
(43) Pub. Date: Jun. 14, 2018

(54) Personal Mobility Device

(71) Applicant: Matthew SILVERWOOD, Mulgrave (AU)

(72) Inventor: Matthew SILVERWOOD, Mulgrave (AU)

(21) Appl. No.: 15/838,083

(22) Filed: Dec. 11, 2017

(30) Foreign Application Priority Data
Dec. 12, 2016 (AU) 2016905125

(51) Int. Cl. B62K 11/00; B60B 19/00; B60K 7/00

(52) U.S. Cl. CPC B62K 11/007; B60K 7/0007; B60B 19/003

(57) ABSTRACT

The present invention is a personal mobility device having multiple modes of operation, including a deck, and a first and second wheel assembly, and at least one battery powered electric motor, and actuation means. The deck includes an elongate substantially flat body, and each wheel assembly is attached to the deck in the vicinity of a respective end of the elongate body. The respective axle of each wheel assembly is located upon the plane of the deck. The at least one battery powered electric motor is adapted to be actuated via the actuation means when a user steps onto the deck, and adapted to drive the first and second wheel assemblies, and wherein in the first mode of operation, both the first and second wheel assemblies are adapted to roll in a circumferential direction, predominately under the influence of the at least one electric motor, so that the device moves in an orthogonal direction to the longitudinal axis of the deck, and wherein in a second mode of operation, both the first and second wheel assemblies are also adapted to optionally free-roll in an orthogonal direction to the plane of the wheel assembly, thereby allowing the device to move substantially in the direction of the longitudinal axis of the deck. There is a transitional mode of operation, where the device is capable of continuously and smoothly transitioning between the first and second mode of operation, while the device is being ridden.

### FIELD OF THE INVENTION

The present invention relates to the field of personal mobility devices such as skateboards, hoverboards, and Segways, and the like.

### BACKGROUND OF THE INVENTION

Personal mobility devices such as skateboards, hoverboards and Segways are common. These types of devices provide recreation and particularly in the case of Segways, they also provide a utilitarian function, and are commonly used by security guards and police to patrol large areas comfortably.

One problem associated with these types of devices is that each is designed to typically have just one mode of operation. In the case of hoverboards and Segways, the device is typically ridden in an orthogonal direction to the longitudinal axis of the deck that a rider stands upon. In the case of a skateboard, these are primarily ridden in the longitudinal direction of the deck that the rider stands upon. Therefore, two separate devices are required to provide both modes of operation.

It is an object of the present invention to provide a personal mobility device that at least ameliorates the aforementioned problem.

### DISCLOSURE OF THE INVENTION

Accordingly, the present invention is a personal mobility device having multiple modes of operation, including a deck, and a first and second wheel assembly, and at least one battery powered electric motor, and actuation means. The deck includes an elongate substantially flat body, and each wheel assembly is attached to the deck in the vicinity of a respective end of the elongate body. The respective axle of each wheel assembly is located upon the plane of the deck. The at least one battery powered electric motor is adapted to be actuated via the actuation means when a user steps onto the deck, and adapted to drive the first and second wheel assemblies, and wherein in the first mode of operation, both the first and second wheel assemblies are adapted to roll in a circumferential direction, predominately under the influence of the at least one electric motor, so that the device moves in an orthogonal direction to the longitudinal axis of the deck, and wherein in a second mode of operation, both the first and second wheel assemblies are also adapted to optionally free-roll in an orthogonal direction to the plane of the wheel assembly, thereby allowing the device to move substantially in the direction of the longitudinal axis of the deck.

Preferably, there is a transitional mode of operation, where the device is capable of continuously and smoothly transitioning between the first and second mode of operation, while the device is being ridden.

Preferably the personal mobility device can continuously and effortlessly transition between the two primary modes of operation, while the user continuously rides the personal mobility device.

Preferably, the device includes adaptable controller means that are used when the device is being ridden by a user, and the adaptable controller means enable the user of the device to control the at least one battery powered electric motor.

Preferably, the battery powered electric motor is adapted to independently drive each wheel assembly in response to the user's input into the adaptable controller means via movement of at least a portion of one or both feet.

Alternatively, the battery powered electric motor is adapted to independently drive each wheel assembly in response to the user's input into the adaptable controller means, and the adaptable controller means are handheld.

In a preferred embodiment of the present invention, each wheel assembly comprises at least a pair of disks, and each disk in the at least a pair of disks includes a plurality of rollers equally spaced about its periphery, and the centre axle for each roller is coplanar with the plane of its respective disk.

Alternatively, in another form of the invention, each wheel assembly comprises a single disk, and each disk includes a plurality of rollers equally spaced about its periphery, and the centre axle for each roller is coplanar with the plane of its respective disk.

Preferably, each roller, in the plurality of rollers, is elongate.

Preferably, each elongate roller has a substantially arcuate shaped sidewall, and the arcuate shape of each roller on each wheel in the wheel assembly, combine to provide a smooth circumferential rolling surface when the device is being operated in accordance with the first mode of operation.

Preferably, when the pair of disks are assembled into a wheel assembly, each disk is positioned, relative to one another, so that the plurality of rollers is out of phase with the plurality of rollers on its neighbouring disk within the pair, so that the effect of the combination of the out of phase rollers provides the wheel assembly with a substantially smooth circumferential rolling surface.

Preferably, the device has a separate battery powered electric motor for each wheel assembly.

Preferably, the separate battery powered electric motor is incorporated within its respective wheel assembly.

In a preferred form, the present invention also includes at least one gyroscope that is adapted to sense variations in the angle of the deck with respect to the at least one gyroscope's preconfigured horizontal setting.

Alternatively, in another preferred form, the present invention includes proximity sensing means that are capable of continuously sensing the distance between each of the longitudinal edges of the deck of the board, relative to the ground.

In yet another preferred embodiment, both at least one gyroscope, and the proximity sensing means are used in combination.

Preferably, the device also includes logic control means.

Preferably, the at least one gyroscope, or the proximity sensing means, or the combination of both, is adapted to feed at least one signal to the logic control means, and the logic control means are adapted to control the operation of the at least one battery powered electric motors in response to variations of the angle of the deck.

Preferably, the at least one battery powered electric motor is adapted to drive the first and second wheel assemblies when the device is used in accordance with the first mode of operation.

Preferably, the at least one battery powered electric motor is adapted to continuously adjust the position of the first and second wheel assemblies while the device is being operated in accordance with the second mode of operation, or any combination of the two modes, as the device is being continuously transitioned between the two modes of operation.

### BRIEF DESCRIPTION OF THE DRAWINGS

FIG. 1 is an isometric view of one preferred embodiment of a personal mobility device that is in accordance with the present invention where each wheel assembly comprises a pair of disks.

FIG. 2 is an isometric view of another preferred embodiment of a personal mobility device that is in accordance with the present invention.

FIG. 3 is an exploded isometric view of a wheel assembly used in association with the personal mobility device.

### DESCRIPTION OF THE PREFERRED EMBODIMENTS

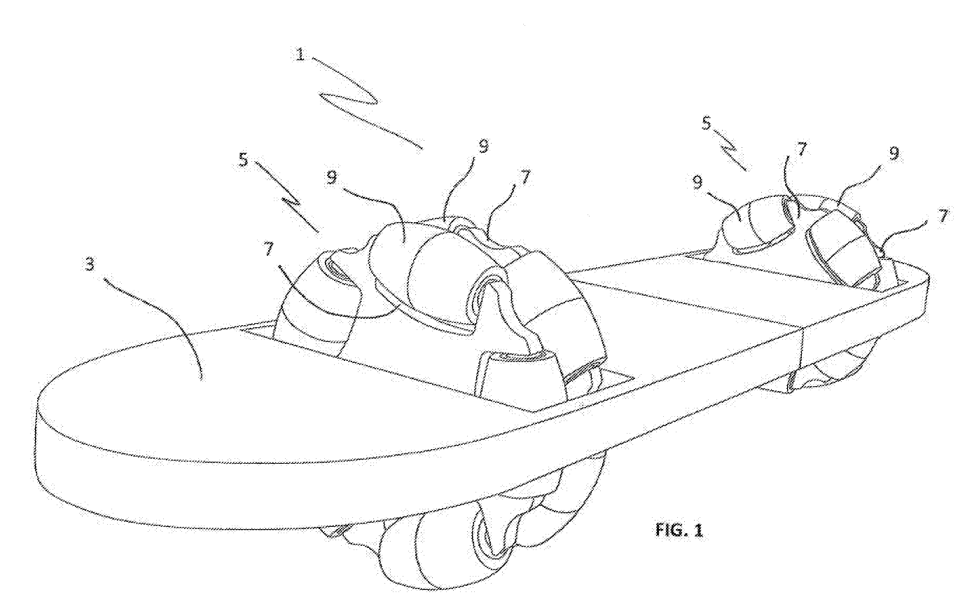

Turning firstly to FIG. 1, we are shown a personal mobility device 1 including a deck 3 and a pair of wheel assemblies 5. The personal mobility device has two main modes of operation. In the first mode, the device is ridden by a rider that stands upright upon the deck 3, and each of the wheel assemblies 5 are independently driven by a battery powered electric motor (not shown) so that each wheel assembly 5 rolls substantially circumferentially. Therefore, in the first mode of operation, the personal mobility device 1 moves substantially orthogonally to the longitudinal axis of the deck 3. At least one gyroscope (not shown) is included, the gyroscope is capable of determining the angle of inclination, or declination, of the deck, relative to the gyroscope's pre-set horizontal. The output signal of the at least one gyroscope is fed into a logic control means (not shown) that is included, and this in turn drives the two wheel assemblies 5 via the at least one battery powered electric motor. The combination of the gyroscope continuously feeding signals to the logic control means enables the rider to control the speed and direction of the personal mobility device 1, while maintaining sufficient stability.

As shown, each wheel assembly 5 includes a pair of disks 7 that are assembled together, side by side, in close proximity. Each disk 7 includes a plurality of rollers 9 that are spaced evenly around the periphery of its respective disk 7. Each roller 9 has an arcuate shaped sidewall. Each of the disks 7 in each wheel assembly 5 are assembled so that the rollers 9 are out of phase with one another. This means that where there is a gap between the spaced apart rollers 9 on one disk 7, there is a roller 9 on its adjacent disk 7. The combination of the rollers 9, with their arcuate shaped sidewall, and out of phase arrangement, means that a substantially smooth peripheral rolling surface is created for each wheel assembly 5.

The rollers 9 provide the personal mobility device 1 with a second mode of operation. In the second mode of operation, the rider still stands substantially upright, however in the second mode of operation, the personal mobility device is ridden in the longitudinal direction of the deck 3. In this mode, the personal mobility device rolls upon the roller or rollers 9 that are in contact with the ground. The at least one gyroscope, and the logic control means, and the at least one battery powered electric motor continue to combine to drive each wheel assembly 5 in a circumferential direction when required, either clockwise or counter-clockwise, as necessary, to assist the rider in maintaining stability when riding in mode 2.

In a preferred form of the invention, a rider of the device is capable of continuously transitioning between the first and second modes of operation, while the device is in continuous use. The skill of the rider, plus the adjustments of the electric motors, in response to the signals received into the logic control means, enable an infinite number of transitional modes of operation between the primary first and second modes.

In a preferred form of the invention, the electrical components of the device 1 are actuated when the weight of the rider is placed upon the deck 3. However, it is also possible that there is at least one foot operated actuation switch in a convenient location upon the riding surface of the deck, that is used to actuate the electrical components of the device.

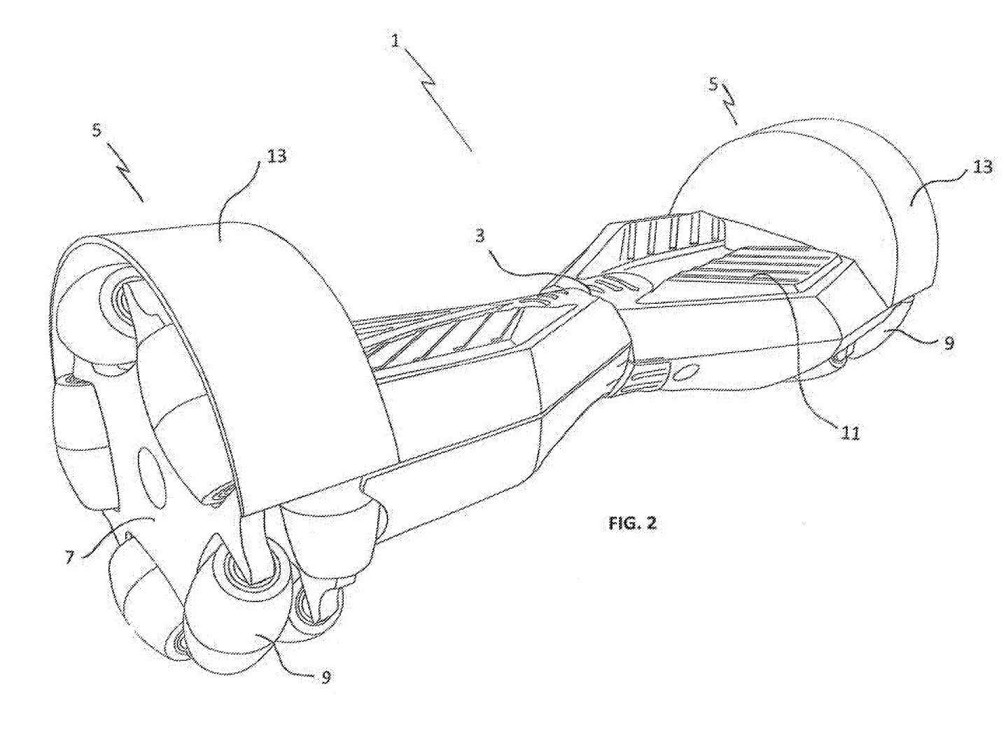

Turning to FIG. 2, we are shown an alternative embodiment of the present invention where a wheel assembly 5 is located at the opposing ends of the deck 3. In this embodiment, the area of the deck 3 that is easily accessible to the rider is increased, and the rider can ride the device using a wider stance, thereby giving him more stability. The wider area also allows more area for the placement of at least one foot operated actuator 11. Optionally, each wheel assembly 5 may include a wheel cover 13. In a preferred embodiment, each wheel cover 13 is also capable of supporting the weight of the rider. This protects the feet of the rider from coming into contact with either of the wheel assemblies 5. This arrangement also enables a standard hoverboard, or other compatible device, such as a Segway, or self-balancing electric scooter, to be retrofitted with the wheel assemblies and other sensor and controller means, thereby giving those devices the ability to be operated in either of the two primary modes, or in an infinite number of transitional modes between the two primary modes.

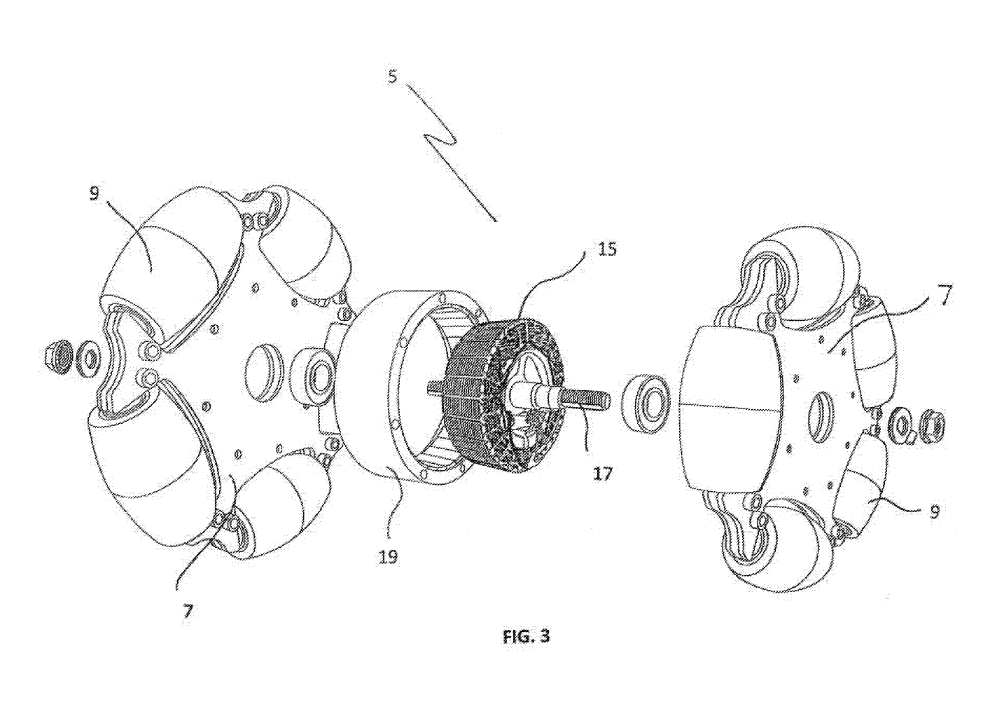

Turning to FIG. 3, we are shown an exploded view of one form of a wheel assembly 5 in accordance with the present invention. In this view, we can see that preferably each wheel assembly 5 includes a battery powered electric motor 15 that is housed in motor housing 19. A wheel axle 17 fastens the disk 7 together and extends sufficiently to enable the wheel assembly to be connected to the deck 3. In a preferred embodiment, the weight of the rider bearing down upon each respective wheel axle 17 in each wheel assembly 5 actuates the electrical components in the device 1.

Optionally in all preferred embodiments of the invention, the electric motors used to drive either each individual wheel assembly, or both wheel assemblies, may also act as brakes where appropriate to do so, to thereby slow down the rotation of each wheel assembly, as required. Further to this, when the electric motors are acting in a braking mode, they may generate an electrical charge that may then be fed back to the battery to increase its storage of electrical charge.

The personal mobility device may also include means to lock the rollers around the periphery of at least one of the disks in each wheel assembly. By locking the rollers, the personal mobility device can then be used like a conventional hoverboard. The locking means for the rollers may be remotely activated, by a rider using a remote control. Or the locking means could be actuated by the rider's foot operating upon a switch, or lever, located on the deck. Or the personal mobility device may be pre-configured manually by a rider to lock the rollers prior to the commencement of the ride. By including the ability to choose the mode of operation for the personal mobility device, the rider can configure the device to best suit the particular terrain that the device will be ridden upon.

Finally, each wheel assembly on the personal mobility device includes independent suspension means to provide a smoother and more stable ride experience as each wheel assembly rolls over the terrain. Also, each axle associated with each wheel assembly, may be able to automatically adjust its angle, relative to the plane of the deck, so that each wheel assembly may dynamically adjust its angle to better conform to the particular terrain that the board is being ridden on. This adjustment of the angle may apply to the wheel assembly as a whole, or individual disks within each wheel assembly.

While the above description includes the preferred embodiments of the invention, it is to be understood that many variations, alterations, modifications and/or additions may be introduced into the constructions and arrangements of parts previously described without departing from the essential features or the spirit or ambit of the invention.

It will be also understood that where the word “comprise”, and variations such as “comprises” and “comprising”, are used in this specification, unless the context requires otherwise such use is intended to imply the inclusion of a stated feature or features, but is not to be taken as excluding the presence of other feature or features.

The reference to any prior art in this specification is not, and should not be taken as, an acknowledgment or any form of suggestion that such prior art forms part of the common general knowledge.

1. A personal mobility device having multiple modes of operation including;
a deck, and
a first and second wheel assembly, and
at least one battery powered electric motor, and
actuation means,
wherein the deck includes an elongate substantially flat body, and each wheel assembly is attached to the deck in the vicinity of a respective end of the elongate body, and wherein the respective axle of each wheel assembly is located upon the plane of the deck, and wherein the at least one battery powered electric motor is adapted to be actuated via the actuation means when a user steps onto the deck, and adapted to drive the first and second wheel assemblies, and wherein in the first mode of operation, both the first and second wheel assemblies are adapted to roll in a circumferential direction, predominately under the influence of the at least one electric motor, so that the device moves in an orthogonal direction to the longitudinal axis of the deck, and wherein in a second mode of operation, both the first and second wheel assemblies are also adapted to optionally free-roll in an orthogonal direction to the plane of the wheel assembly, thereby allowing the device to move substantially in the direction of the longitudinal axis of the deck.

2. The personal mobility device as defined in claim 1 wherein there is a transitional mode of operation, where the device is capable of continuously and smoothly transitioning between the first and second mode of operation, while the device is being ridden.

3. The personal mobility device as defined in claim 2 wherein the device includes adaptable controller means that are used when the device is being ridden by a user in the first mode of operation, and the adaptable controller means enable the user of the device to control the at least one battery powered electric motor.

4. The personal mobility device as defined in claim 3 wherein the battery powered electric motor is adapted to independently drive each wheel assembly in response to the user's input into the adaptable controller means via movement of at least a portion of one or both feet.

5. The personal mobility device as defined in claim 2 wherein each wheel assembly comprises a pair of wheels, and each wheel in the pair of wheels includes a plurality of rollers equally spaced about its periphery, and the centre axle for each roller is coplanar with the plane of its respective wheel.

6. The personal mobility device as defined in claim 5 wherein when the pair of wheels are assembled into a wheel assembly, each wheel is positioned, relative to one another, so that the plurality of rollers are out of phase with the plurality of rollers on its neighbouring wheel within the pair, so that the effect of the combination of the out of phase rollers provides the wheel assembly with a substantially circular circumferential rolling surface.

7. The personal mobility device as defined in claim 6 wherein each roller, in the plurality of rollers, is elongate.

8. The personal mobility device as defined in claim 7 wherein each elongate roller has a substantially arcuate shaped sidewall, and the arcuate shape of each roller on each wheel in the wheel assembly, combine to provide a substantially circular circumferential rolling surface when the device is being operated in accordance with the fist mode of operation.

9. The personal mobility device as defined in claim 2 wherein the device has a separate battery powered electric motor for each wheel assembly.

10. The personal mobility device as defined in claim 9 wherein the separate battery powered electric motor is incorporated within its respective wheel assembly.

11. The personal mobility device as defined in claim 2 wherein the device includes at least one gyroscope that is adapted to sense variations in the angle of the deck with respect to the first and second wheel assemblies.

12. The personal mobility device as claimed in claim 11 wherein the device includes logic control means.

13. The personal mobility device as claimed in claim 12 wherein the at least one gyroscope is adapted to feed at least one signal to the logic control means, and the logic control means are adapted to control the operation of the at least one battery powered electric motors in response to variations of the angle of the deck, relative to the first and second wheel assemblies.

14. The personal mobility device as claimed in claim 13 wherein the at least one battery powered electric motor is adapted two drive the first and second wheel assemblies when the device is used in the first mode of operation.

15. The personal mobility device as claimed in claim 13 wherein the at least one battery powered electric motor is adapted to continuously micro adjust the position of the first and second wheel assemblies while the device is being operated in accordance with the second mode or transitional mode of operation.
